(19) United States
(12) Patent Application Publication
(10) Pub. No.: US 2023/0176934 A1
(43) Pub. Date: Jun. 8, 2023

(54) OBJECT LINEARIZATION FOR COMMUNICATIONS

(71) Applicant: Intel Corporation, Santa Clara, CA (US)

(72) Inventors: Robert SOULE, Hamden, CT (US); Rajit MANOHAR, New Haven, CT (US); Jr-Shian TSAI, Portland, OR (US); Edmund CHEN, Sunnyvale, CA (US); Uri V. CUMMINGS, Saratoga, CA (US); Pietro BRESSANA, Grono (CH); Rui LI, Sunnyvale, CA (US)

(21) Appl. No.: 18/090,373

(22) Filed: Dec. 28, 2022

Related U.S. Application Data
(60) Provisional application No. 63/405,759, filed on Sep. 12, 2022.
(60) Provisional application No. 63/405,775, filed on Sep. 12, 2022.

(51) Int. Cl. G06F 9/54

(52) U.S. Cl. CPC G06F 9/547; G06F 9/544

(57) ABSTRACT

Examples described herein relate to a network interface device that includes packet processing circuitry and circuitry. In some examples, the circuitry is to execute a first process to provide a remote procedure call (RPC) interface for a second process. In some examples, the second process comprises a business logic. In some examples, resource and deployment definitions of the first and second processes are based on an Interface Description Language (IDL) and a memory allocation. In some examples, the memory allocation among the processes provides share at least one RPC message as at least one formatted object accessible from memory.

### RELATED APPLICATION

This application claims the benefit of priority to U.S. Provisional Applications 63/405,759 and 63/405,775, both filed Sep. 12, 2022. The entire contents of those applications are incorporated by reference.

### BACKGROUND OF THE INVENTION

In data centers, some software deployments have transitioned from monolithic design to finer-grained decompositions, including service-oriented architectures and microservices. Microservices rely on communications between distributed microservices. Communication paths can be provided by one or more service meshes. Some microservices communicate using remote procedure calls (RPCs). A RPC allows a computer program (e.g., a client) to execute a procedure on a different machine (e.g., a server), while maintaining the abstraction of a local procedure call as a procedure can be invoked on a different machine as though invoked on a local machine. When the client invokes the remote procedure, an RPC library handles marshaling data networking, security, and other features to enable communication.

### BRIEF DESCRIPTION OF THE DRAWINGS

FIG. 1 depicts an example architecture of an application using gRPC.

FIG. 2 illustrates an implementation architecture of an application using split gRPC with a separate process for accelerating the gRPC infrastructure functions.

FIG. 3 depicts the functional partitioning and call flow for the split gRPC. The business logic remains on the host compute while the gRPC infrastructure process can run on either on the host or on an Infrastructure Processing Unit (IPU).

FIG. 4 depicts a system that can perform data linearization in connection with communications between an RPC software stack and a network interface device.

FIG. 5 depicts an example of an object.

FIG. 6 depicts an example of linearizing an object.

FIG. 7 depicts an example of a linearized object that can be generated.

FIG. 8A depicts a simple C++ class.

FIG. 8B depicts an example object.

FIG. 8C shows a case of a simple inheritance.

FIG. 8D depicts an example block allocation approach.

FIG. 8E depicts a class with a virtual function.

FIG. 8F depicts an example manner to process a virtual function table.

FIG. 9A depicts an example process.

FIG. 9B depicts an example process.

FIG. 10 depicts an example network interface device.

FIG. 11 depicts an example system.

FIG. 12 depicts an example system.

### DETAILED DESCRIPTION

Some examples attempt to accelerate RPC communications and reduce processor workloads that provides an application-independent infrastructure in separate and independent processes that can be run on a processor or accelerated by an accelerator. An RPC framework can be executed as business logic (e.g., application, microservice, process, thread, container, virtual machine, or other) and an RPC infrastructure stack. The business logic can be executed by one or more processors whereas the RPC infrastructure stack and data transformation can be executed by one or more accelerators and independently scale and be accelerated. For example, a C++ prototype allows application developers to include a new header file and link against a software library. Some examples can partition applications that use remote procedure call into two separate processes, such that the business logic runs in one process and the remaining RPC connectivity functions (provided in the RPC core and transport logic for networking, policy, observability, data transformation, security, etc.) executes in a separate process. Partitioning the application allows capability to leverage additional accelerators to scale-up resources and improve overall application performance by increasing parallelism through pipelined processing, or when using an accelerator, to reduce load on the host CPU. A network interface device can provide a secure zone for the RPC infrastructure functions such as authentication, encryption, load balancing, policy enforcement, observability, key management, and isolation from compromised systems.

Some examples where this partitioned architecture can be applied as an extension are to Google's gRPC software framework or Apache Thrift, or services built over gRPC such as Apache Arrow Flight. gRPC message format stored as objects can include primitive and composite types, as well as optional, repeated, and nested fields.

A compiler can generate partitioned processes with resource and deployment definition (e.g., available accelerators, interface bandwidths, access latency) and schema Interface Description Language (IDL). The compiler can generate a shared linearized object structure, for access and transfer between a business logic and communication process. The compiler can generate programming language classes and object access methods for linearized structure for software and data structure template that can be used by hardware acceleration. For example, a linearized structure can include a C++ object where member data references are in one or more contiguous memory blocks. The generated linearized object structure can be transferred between partitioned processes and be directly accessed by the programming language. For example, when transferring the linearized object structure across a device interface, the linearized object structure aggregates multiple objects into contiguous physical memory zones.

Generated business logic and communication process can access available accelerators enabled based on defined usage and available accelerators, such as data transformation, encryption, reliable transport, load balancing, authentication, observability. Generated processes can access memory allocation such as arena and non-arena based memory allocations, memory allocation near processing cores (e.g., sub-NUMA awareness), processing requirements for security, observability and data transformation, and dedicated request and completion queues to minimize access latency and contention.

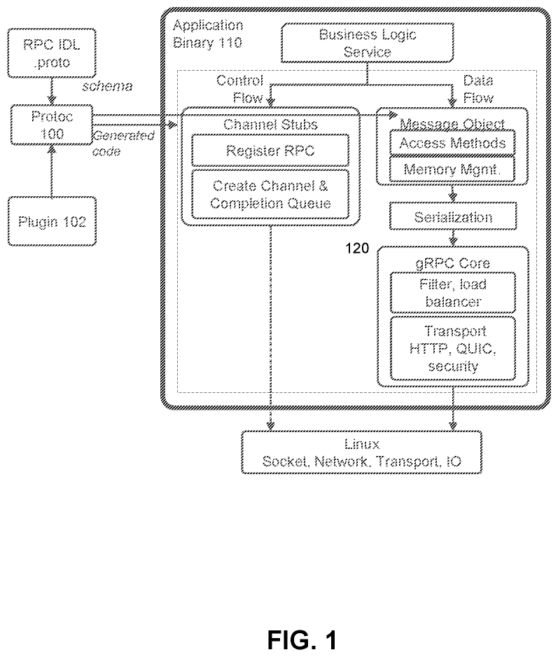

FIG. 1 depicts an example of architecture of an application using gRPC. A developer can specify a procedure interface in a domain specific language called an Interface Description Language (IDL), such as RPC IDL.proto. The developer can execute a compiler (protoc 100 (e.g., protobuffer compiler) that can generate stub code, to provide a type-safe interface between application 110 and remote procedure logic. According to a configuration from plugin 102, proto 100 can generate regular gRPC output C++ code with object representations and stub code for methods and generate executable code for at least one processor and at least one accelerator code to perform linearization of objects on a per message basis. The proto 100 can generate the following memory layout for C++ objects: simple fields stored directly as members of a class, message fields are stored as class members, auxiliary variables (e.g., cached size computation) to be initialized, optional fields can include flags that indicate if the fields were set or not, repeated fields, and/or Maps. Auxiliary variables can be set to zero to indicate they have not been computed. Auxiliary members can be automatically generated by the protoc compiler for a priori determination. Repeated fields can use Google's RepeatedField class, that has the following sub-fields: current_size (4 bytes), total_size (4 bytes), and a pointer to the arena or elements (8 bytes) and the pointer is used to indicate the arena or the location of elements. Maps can use Google's Map class, which can be internally organized as a hash table with a bucket list. If a bucket list becomes too long, the local buckets can be converted into a std::map. If maps are stored using hash tables, buckets for a hash table can be allocated in memory and hash table constructed from the buckets.

Stub code can provide an interface to use RPC library code. The developer can link their business logic service with an RPC library 120, which is responsible for data serialization, memory management, networking, and other features such as load balancing and security. Application binary 110 can be formed by linking and compile a business logic service, control stubs, and RPC library to generate a message object, perform data serialization, networking to remote procedure as well as load balancing among remote procedures, transport, encryption. RPC libraries can add overhead to communications, with RPCs utilize computation capabilities and adding latency to communications. A single service may trigger hundreds or thousands of RPC calls.

As part of the partitioned split RPC, protoc compiler plugin 102 can generate two separate executables and in addition to generating the traditional stub code, also generates type safe code for the application and a shepherding layer that provides an interface between the two processes. The shepherding layer provides a communication channel between the separate processes. The shepherding layer can be inserted between two compute elements running business logic and RPC infrastructure connectivity functions (in software and hardware). Extensions to the RPC library can be provided to interact with the shepherding layer from the separate process.

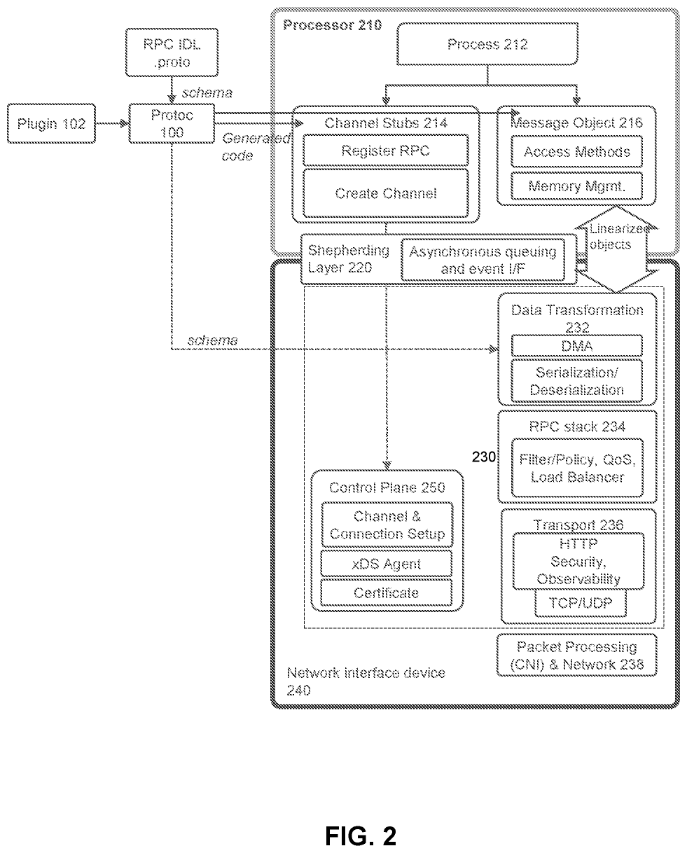

FIG. 2 illustrates an implementation of a split architecture with a business logic process that communicates using an RPC. A modified Plugin 102 for split gRPC can cause protoc 100 to generate two separate processes, namely, business logic process 212 executed by host processor 210, and process 230 that performs at least gRPC infrastructure operations and can be executed by network interface device 240. Channel stubs 214 and memory object 216 can execute on host processor 210. The split gRPC can use channel stub APIs 214 to register an RPC and manage a channel. These requests can be proxied by control plane process 250 to be executed as part of the gRPC infrastructure in RPC stack 234, transport 236, and packet processing 238.

RPC stack 234 can perform operations of an embedded service mesh to communicate with a remote endpoint. A remote endpoint can use a reliable transport such as TCP or others. A local endpoint can replace TCP with direct memory access (DMA). The endpoint location can further lead to modifications of data inflight encryption, compression, data transformation, or others.

RPC stack 234 and transport 236 can perform local and remote communication endpoints. A local endpoint may not utilize a Hypertext Transfer Protocol (HTTP) layer and can store message metadata using operations of a DMA or data streaming architecture (DSA). For example, a DSA can perform one or more of: DMA operations, generate and test cyclic redundancy check (CRC) checksum, or Data Integrity Field (DIF) to support storage and networking applications; memory compare and delta generate/merge to support VM migration, VM Fast check-pointing and software managed memory deduplication usages, input-output memory management unit (IOMMU) operations, as well as Peripheral Component Interconnect Express (PCIe) Address Translation Services (ATS), Page Request Services (PRS), Message Signaled Interrupts Extended (MSI-X), and/or Advanced Error Reporting (AER).

In a host server, processor 210 can execute message object 216 to access methods to linearize objects, perform memory management, and perform object linearization for objects sent to network interface device 240. For example, message object 216 and/or data transformation 232 can perform serialization or de-serialization of data or objects as well as linearization of objects provided to processor 210. Linearized objects can be directly copied by direct memory access (DMA) by data transformation 232 to memory accessible to processor 210 in a host server. In some examples, message object 216 and/or data transformation 232 can place the deserialized objects as linearized objects in memory accessible to processor 210 or linearized objects in memory accessible to data transformation 232 for serialization. Linearization can store objects compactly in an order in memory for access without reordering by a receiver (e.g., process 212 or RPC operations 230).

In accordance with an RPC specification, RPC stack 234 can perform packet filtering, policy application, quality of service (QoS) application, load balancing, traffic steering, and routing. Transport 236 can perform HTTP access, security application, observability, and reliable transports, such as Transmission Control Protocol (TCP), Quick User Datagram Protocol (UDP) Internet Connections (QUIC), or others. Packet processing 238 can perform packet processing such as for container network interfaces (CNI) or virtual switching (vSwitch) in accordance with applicable network standards. Processing can be extended to include proxyless service mesh functionalities such as authentication, mutual zero trust security, load balancing, traffic steering, routing, and others.

Process 212 and RPC operations 230 can communicate through a communication channel (e.g., shepherding layer 220 (e.g., at least one process)) that executes on processor 210 and network interface device 240. Shepherding layer 220 can provide a communication interface through a shared memory between processor 210 and network interface device 240. Shepherding layer 220 can provide for a deployment configuration such as leveraging available direct memory access (DMA), shared memory, polling threads, timers, batch sizes, and so forth.

For example, when executed by network interface device 240, shepherding layer 220 can generate a descriptor for a received packet to indicate a location of object storage. Shepherding layer 220 executed on processor 210 can polls for data or objects copied to a memory region (e.g., by direct memory access (DMA)) and can invoke process 212 to access an object handle associated with the linearized object.

RPC requests/responses can be stored as one or more linearized objects into a memory-layout stream in a shared memory between process 212 and RPC operations 230. Intra-process communication by data copies or shared memory between the address spaces of the core and accelerator can be reduced by performing object linearization that organizes an instance of an RPC message into a contiguous block of memory. The block of memory can be accessed as one or more valid objects (e.g., C++ object or other object oriented programming language (e.g., Go, Java, Rust)). In some examples, linearized objects can be retrieved as non-contiguous data regions and stored as a contiguous memory. In some examples, common objects can be represented as a contiguous sequence of bytes in memory in a manner where they can directly be placed in the destination memory and accessed as a valid object in the programming language used to implement the computation. In some examples, an entire object can be transferred from processor 210 to network interface device 240 or network interface device 240 to processor 210 in a single transaction. In some examples, after copied, the object can be accessed directly without any additional memory copies.

Reference to network interface device 240 can refer to one or more of: a network interface controller (NIC), a remote direct memory access (RDMA)-enabled NIC, SmartNIC, router, switch, forwarding element, infrastructure processing unit (IPU), data processing unit (DPU), accelerator, or network-attached appliance (e.g., storage, memory, accelerator, processors, and/or security).

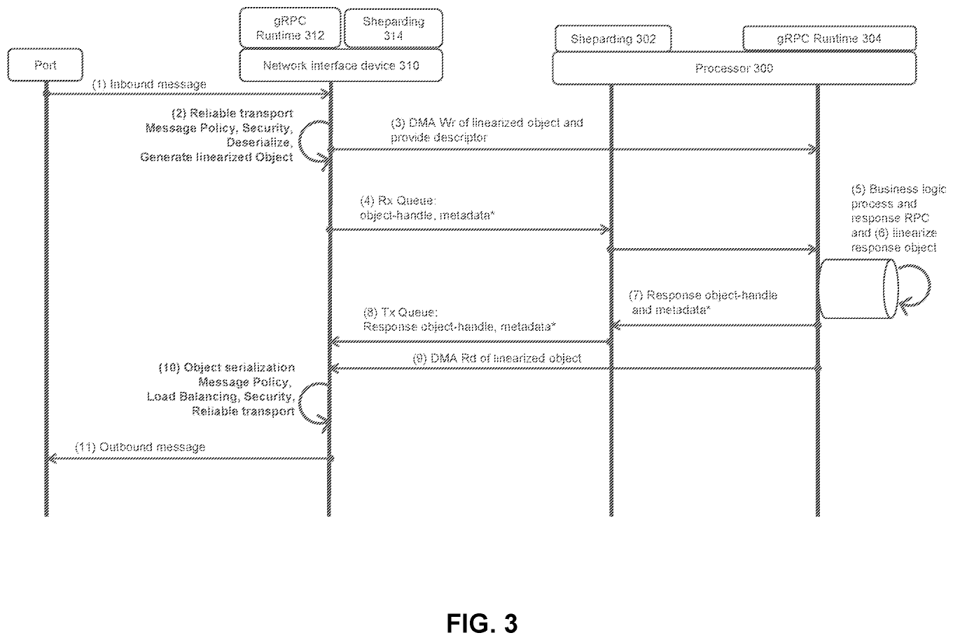

FIG. 3 depicts a partitioned RPC deployment such that a first process runs on a host CPU and a second process runs on a network interface device or accelerator or compute. When messages arrive on the network interface device's network interface, at (1) they are sent to network interface device 310 to perform (2) one or more of: networking, data marshalling, policy, load balancing, observability, QoS, and security processing. At (3), network interface device 310 places message objects into a contiguous memory region using linearization, described herein. At (4), network interface device 310 provides an linearized region containing object handle and meta data for the received message via a shepherding layers 314 and 302 for access by gRPC runtime 304. Metadata for RPC and CPU-network interface device can include stream-ID, RPC-method, timestamps, length, status, connection-ID, quality of service (QoS), and others. At (5), gRPC runtime 304 can access the object, executes business logic, and at (6) generate a response.

At (7), gRPC runtime can provide an object handle and meta data for the response, places message objects into a contiguous memory region using linearization and object via shepherding layers 302 and 314. At (8), via a transmit queue, network interface device 310 can access the object handle and meta data for the response object. At (9), gRPC runtime 304 can DMA the linearized response object into a local contiguous memory region for access by network interface device 310. At (10), network interface device 310 can perform processing such as object serialization, apply message policies, perform load balancing, traffic steering, security, observability, and reliable transport for data in the response object to be sent to a requester (e.g., client that sent the inbound message) or other service.

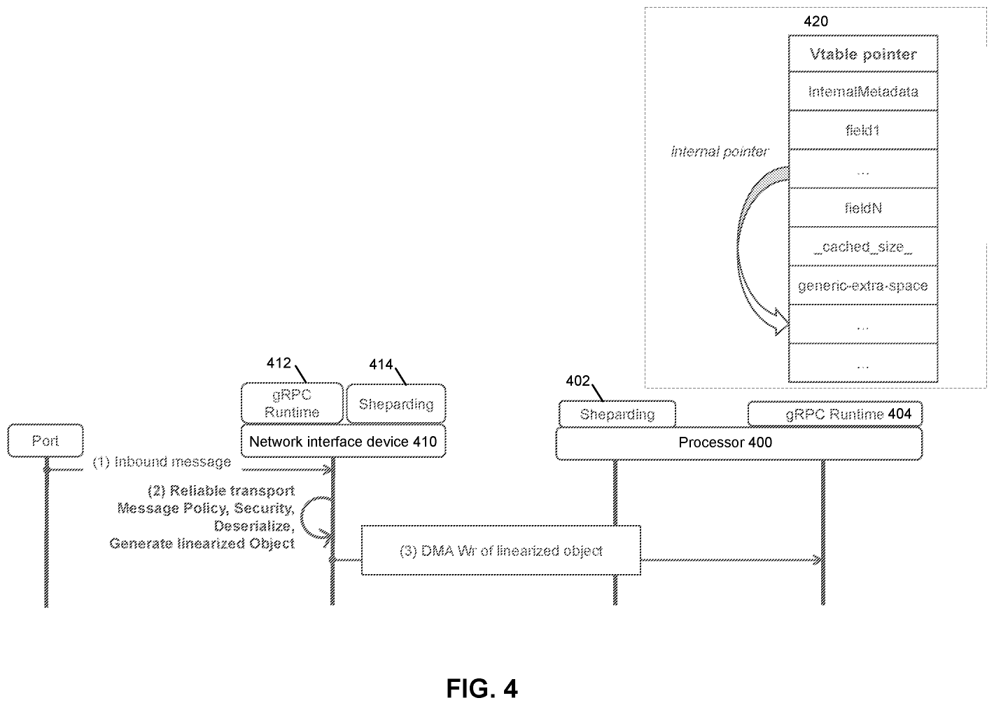

FIG. 4 depicts a system that can perform data linearization in connection with communications between an RPC software stack and a network interface device. Some examples partition RPC-based processes (e.g., microservices, virtual machine (VMs), microVMs, containers, process, thread, or other virtualized execution environment) so that business logic (e.g., gRPC runtime 412) can execute on processor 400 (e.g., central processing unit (CPU) core, graphics processing unit (GPU), general purpose GPU (GPGPU), or others) and other processes, such as data transformation and/or a networking stack, can execute on one or more accelerators (e.g., network interface device 410). For example, processor 400 can be part of a server or host system communicatively coupled to network interface device 410 using a network, device interface, bus, or other technologies. A device interface can provide communications based on PCIe, Compute Express Link (CXL), Universal Chiplet Interconnect Express (UCIe), or other connection technologies described herein. See, for example, Peripheral Component Interconnect Express (PCIe) Base Specification 1.0 (2002), as well as earlier versions, later versions, and variations thereof. See, for example, Compute Express Link (CXL) Specification revision 2.0, version 0.7 (2019), as well as earlier versions, later versions, and variations thereof. See, for example, UCIe 1.0 Specification (2022), as well as earlier versions, later versions, and variations thereof.

For example, in connection with packets received or to be transmitted as part of an RPC or other communication, a communication interface over shared memory (e.g., shepherding) can be performed by processor 400 and/or network interface device 410. For a packet received on a port, to perform shepherding 414, network interface device 410 can generate a descriptor for the received packet whereas to perform shepherding 402, processor 400 can poll for a linearized object copied (e.g., DMA) to a region of memory allocated to a DMA circuitry and invoke business logic based on object handle (e.g., gRPC runtime 404). For a packet to be transmitted by a port, to perform shepherding 402, processor 400 can generate a descriptor for the packet poll for a linearized object copied (e.g., DMA) to a region of memory allocated to the DMA circuitry and to perform shepherding 414, network interface device 410 can process the descriptor and cause a packet to be transmitted with the object referenced by the descriptor.

For example, to perform a networking stack and data transformation, network interface device 410 can access an RPC library logic for reliable transport, message policy application, decryption, deserialization, and linearization of objects and so forth in accordance with a utilized RPC protocol.

Data provided by business logic executed by processor 400 can be represented as an object for processing by network interface device 410. Likewise, data provided by network interface device 410 for processing by business logic executed by processor 400 can be represented as an object. An object can be represented as a class with memory variables and pointers to functions that can be performed on the object. To treat data as an object, data is to be formatted in an object structure. The object may have references to other objects or data at arbitrary locations in memory. The transfer or copying of multiple non-contiguous memory regions per object can lead to increased transfer or copying latency.

In some examples, data can be provided as a linearized object prior to or during transfer or copy from network interface device 410 for access by business process logic executed by processor 400 and/or transfer or copy for access by network interface device 410 from business process logic executed by processor 400. Providing data as a linearized object can include storing one or more objects in contiguous memory and aligned to treat as an language specific compatible object. An object can be read as an object by business logic or network interface device 410 and processed as an object, thereby saving time needed to transform data to an object. In other words, a receiver (e.g., business logic or network interface device 410) may not perform additional object setup and layout operations for data to be presented as an object in memory.

Linearization can include calculating extra space needed for object and function to linearizing object given location of extra space. Calculating extra space can include a recursive call to the same function for nested objects. Linearizing object can include base fields written as before, while advancing extra space pointer and for nested fields, recursive call with new object offset.

For example, at (1) for an inbound message received in one or more packets received by a port, various network processing and data transformation can be performed at (2). Network processing and data transformation can include reliable transport, congestion control, message policy application, decryption, deserialization, and linearization of at least a portion of the inbound message as one or more objects. An inbound message can be formatted in accordance with an RPC standard. For example, linearization of at least a portion of the inbound message as one or more objects can follow object format 420. Object format 420 can include data fields such as simple fields that are part of a base object storage, repeated fields, strings, nested messages, Maps, or other information. Various examples of linearization are described herein.

With reference to object format 420, a continuous region of memory can be allocated and a valid object can be created where pointers or offsets are within a region. A message object can include embedded pointers (e.g., strings, repeated fields, nested fields, etc.). Certain cases result in memory requirements known at run-time, such as strings, optional fields, repeated fields, repeated messages, repeated strings, or nested message that contains one of the above. Repeated messages and strings can use different data-structure versus normal repeated fields. Virtual table (Vtable) pointer points to one or more memory locations of one or more function definitions (e.g., code to be executed) of an object. A simple field can include fixed fields (e.g., embedded directly in an object) or short strings (e.g., embedded directly in an object). A field can have internal pointer to a string in an arbitrary location within contiguous region of linearized object. Long strings can include pointer to a buffer to hold a long string. Repeated fields can include pointer to an array of fields. Nested fields can include one or more pointers to a message. Repeated pointer fields (e.g., repeated strings, repeated messages) can include one or more pointers to array of pointers.

At (3), direct memory access (DMA) Write (Wr) of linearized object, network interface device 410 can copy the linearized object in its address space using DMA operation to the address space of a process running on processor 400 (e.g., business logic or gRPC runtime 404). DMA Write of linearized object can perform arena-based allocation, described herein. For example, DMA Write of linearized object can include a memory allocation operation to access a pointer to memory region to write-to. With arena memory, a memory allocation operation can access memory available for DMA circuitry and a receiver can access data from the memory allocated for the DMA circuitry instead of writing the linearized object to virtual address space and copying the linearized object to a memory where the receiver can access the linearized object. Accordingly, processor 400 can access the linearized object directly from memory as a valid object, avoiding additional memory copies to form an object. Moreover, the linearized object can be copied in a single transaction.

Linearized objects can be sent between the two processes using a ring buffer that allows concurrent reads and writes from multiple processes. The particular ring buffer design may not utilize locks when data is being written or read from the buffer, allowing for efficient access. The ring buffer allows for multiple-producer multiple-consumer inter-process communication.

Although examples are described with respect to network interface device 410, other devices or accelerators can be used such as GPUs, GPGPUs, CPUs, DMA engine, or other circuitry.

Various examples described next relate to an RPC utilizing a protocol buffer (protobuf) to send or receive messages between processes, e.g., gRPC, Apache Thrift, Avro, or other RPCs. When a message arrives from a network, protobuf data from the message can be accessed to construct a linearized C++ object, as described herein. RPC messages (e.g., gRPC protocol buffer messages) can include fields of different scalar data types (e.g., bytes, string, boolean, various numeric types, and enumerations). Fields may be optional, repeated, or nested, which allows for the creation of composite types (e.g., lists or maps).

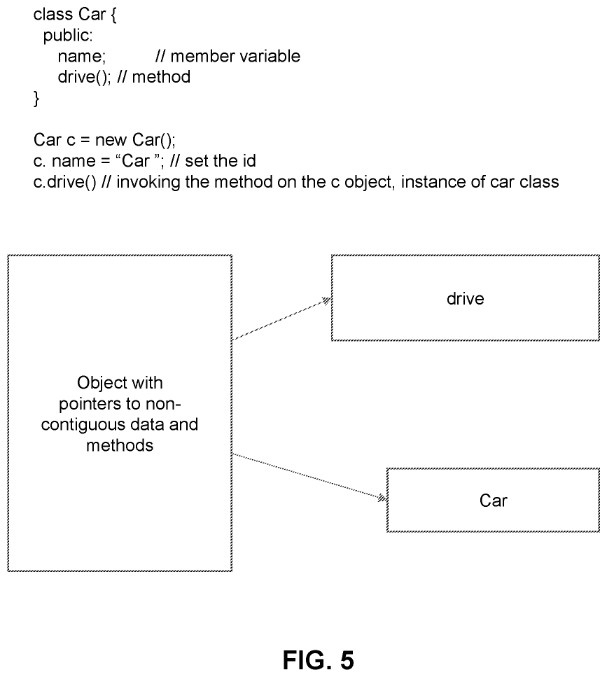

FIG. 5 depicts an example of an object. In this example, the object is a C++ object that can be generated from a portion of a protobuff message (e.g., strict subset of the protobuff message). An object can include pointers to non-contiguous data and functions (e.g., methods). For example, an object can refer to a data (e.g., car) and method (e.g., drive).

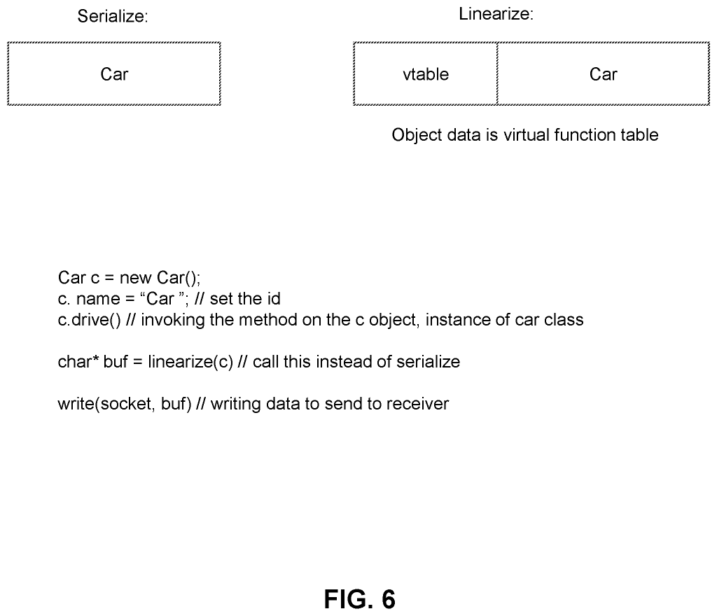

FIG. 6 depicts an example of linearizing an object. Whereas serializing an object can copy an object to contiguous region of memory, an object can be linearized as described herein. Command “char*buf=linearize(c)” can cause generation of a virtual function table with pointers to data in contiguous memory addresses and methods. For example, linearizing an object can generate an object format such as that of format 420 of FIG. 4. For example, a linearized C++object can be stored in memory in a manner that can be processed as an object without re-arrangement or copying of one or more portions of the C++ object, thereby reducing memory copy operations prior to processing an object. Use a contiguous region of memory addresses allow for copying of an object in a single transaction.

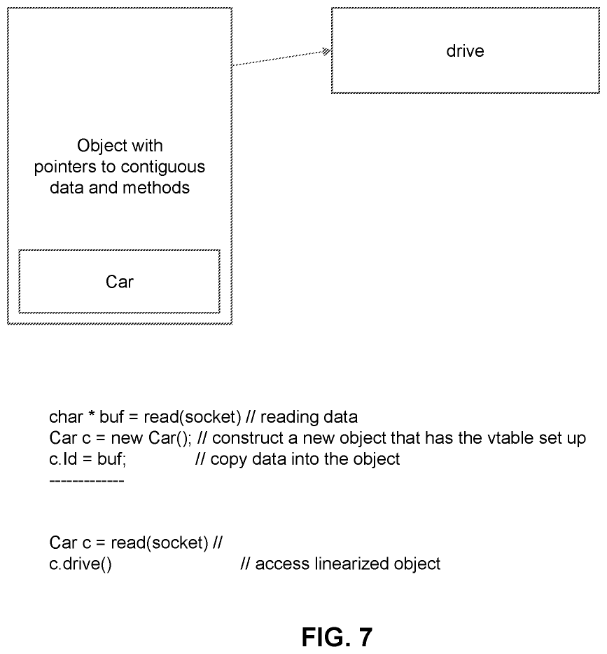

FIG. 7 depicts an example of a linearized object that can be generated. Command “char*buf=read(socket)” can cause reading data. Command “Car c=new Car( )” can cause constructing a new object that has the vtable set up (e.g., format 420). Command “c.Id=buf” can cause read data to be copied into the object. Command “c.drive( )” can cause accessing the linearized object. Note that command “buf drive( )” is not performed, because the vtable does not point to the drive method instructions.

For example, C++ objects can be associated with arena-based and non-arena based memory allocation. When non-arena based allocation is used, components of the message are heap-allocated so the protobuf structure in memory contains pointers to data rather than data itself. Strings are heap-allocated, even when arenas are used. Hence, to preserve compatibility with existing user-written code that uses protobuf, this behavior can be preserved. To improve efficiency, a replacement for “std::string” can be used that also uses arena-based allocation to store linearized objects.

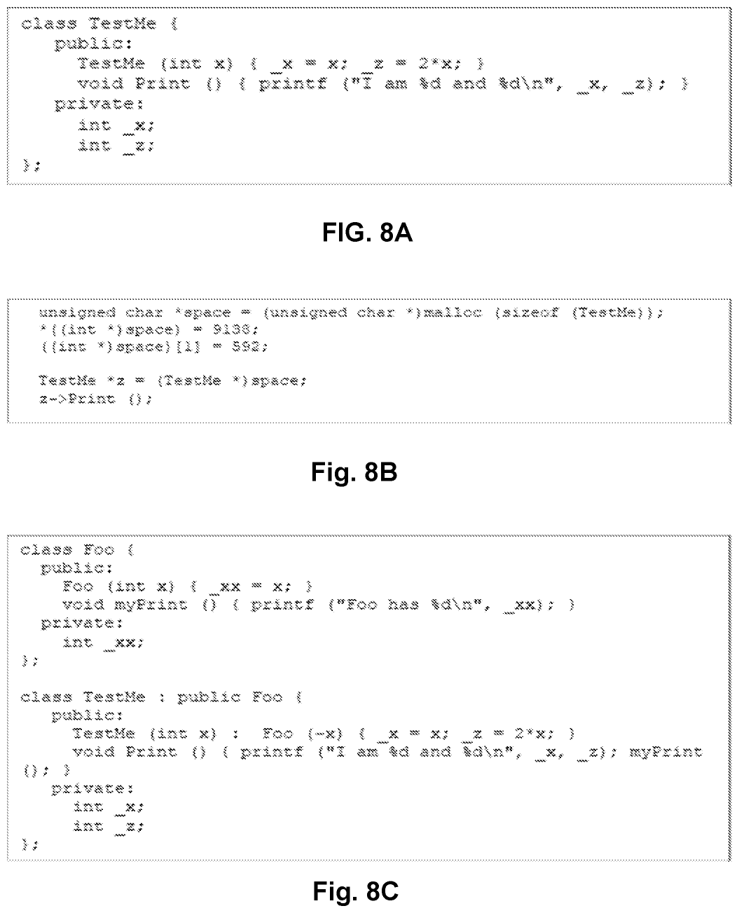

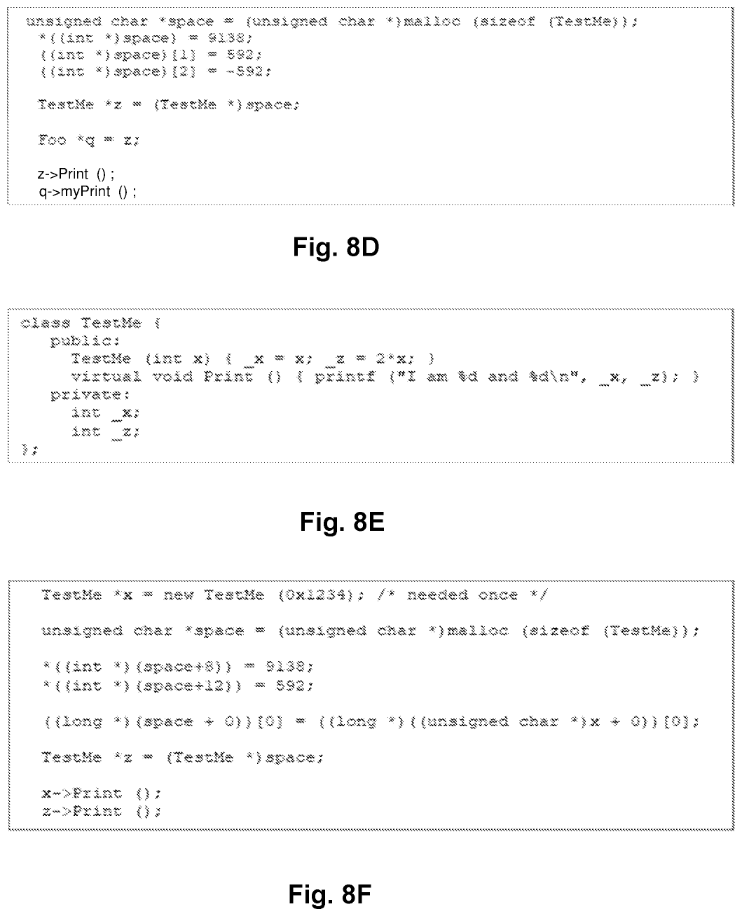

FIG. 8A depicts a simple C++ class. The object format in a memory for this class could correspond to the data in the class. Fields could satisfy the same alignment requirements as in a simple C structure.

FIG. 8B depicts an example object. Assuming an integer is four bytes, the object would be aligned on a 4-byte boundary, the integer “x” would be at offset 0, and the integer “y” would be at offset 4 from the start of the object. An object can be created where “z” behaves as a normal C++ object.

FIG. 8C shows a case of a simple inheritance. In this case, the parent class' members are allocated before the child class so that pointer casting works without overhead (e.g., a child class pointer can be used as a parent class pointer). Once again, alignment constraints apply in the usual way.

FIG. 8D depicts an example block allocation approach. Members are allocated in contiguous memory, with offsets determined by field sizes and alignment considerations. The object layout changes in the presence of virtual methods. Virtual functions can be supported by a virtual function table (e.g., object format 420). An object can be stored in a methods table, and the object has a pointer to this methods table.

FIG. 8E depicts a class with a virtual function. In an objected oriented language, a virtual function may be inherited from a base class or defined in a derived class. Resolution of class of the virtual function can be made using lookup table called a vtable. Linearization can set pointers in the vtable to refer at least to one or more memory locations of one or more function definitions (e.g., code to be executed) of an object.

FIG. 8F depicts an example manner to process a virtual function table. Protobuf objects inherit virtual functions from a message. Hence, for a protobuf object, a dummy object can be created up-front, and then the virtual function table pointer used to create objects. A dummy object can be created and a function table pointer used in subsequent objects that use block allocation. The combination of inheritance and virtual functions can utilize a virtual table pointer for the object, and fields in accordance with a C++ object format.

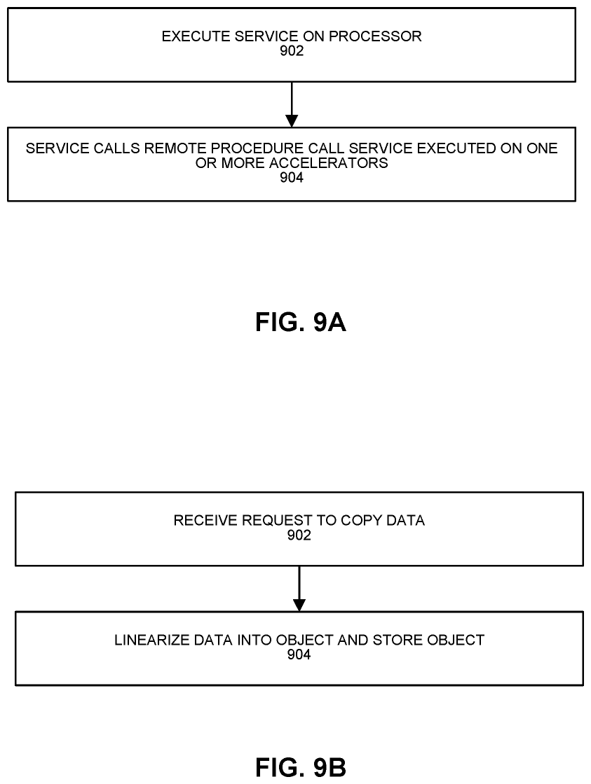

FIG. 9A depicts an example process in connection with RPC communications. At 902, business logic can be executed on a processor. The business logic can generate data to be transmitted in a RPC message as part of an RPC and/or process data received as part of a protocol buffer message as part of an RPC. At 904, one or more accelerators can perform RPC communications such as data transformation and network protocol processing for protocol buffer messages to be sent as part of an RPC. In some examples, for received protocol buffer messages, the one or more accelerators can perform data transformation and network protocol processing prior to providing at least one object to memory accessible by the business logic. In some examples, a compiler can generate separate business logic and RPC communications processes for execution by a host processor and at least one accelerator, respectively.

FIG. 9B depicts an example process. The process can be performed in connection with communication of content of a protocol buffer message from the business logic to the RPC communications or from the RPC communications to the business logic. At 950, an available protocol buffer message can be available to transfer. For example, the available protocol buffer message can be a protocol buffer message that is to be transmitted or an available protocol buffer message received that is to be provided to the business process logic. At 952, content of the message can be linearized and stored into memory. For a protocol buffer message from the business logic to the RPC communications process, memory can be accessible by the RPC communications process. For a protocol buffer message from the RPC communications to the business logic, memory can be accessible by the business logic. Linearizing can include writing a C++ object in a contiguous addressable memory regions.

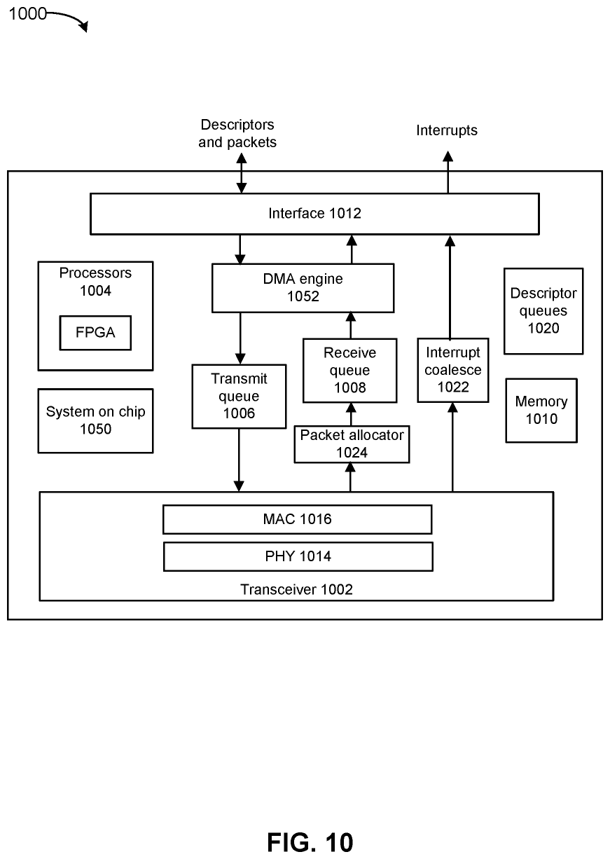

FIG. 10 depicts an example network interface device. In some examples, processors 1004 and/or FPGAs 1030 can be programmed to perform linearization and object transfer, as described herein. Some examples of network interface 1000 are part of an Infrastructure Processing Unit (IPU) or data processing unit (DPU) or utilized by an IPU or DPU. An xPU can refer at least to an IPU, DPU, graphics processing unit (GPU), general purpose GPU (GPGPU), or other processing units (e.g., accelerator devices). An IPU or DPU can include a network interface with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Network interface 1000 can include transceiver (e.g., network interface) 1002, processors 1004, transmit queue 1006, receive queue 1008, memory 1010, and bus interface 1012, and DMA engine 1052. Transceiver 1002 can be capable of receiving and transmitting packets in conformance with the applicable protocols such as Ethernet as described in IEEE 802.3, although other protocols may be used. Transceiver 1002 can receive and transmit packets from and to a network via a network medium (not depicted). Transceiver 1002 can include PHY circuitry 1014 and media access control (MAC) circuitry 1016. PHY circuitry 1014 can include encoding and decoding circuitry (not shown) to encode and decode data packets according to applicable physical layer specifications or standards. MAC circuitry 1016 can be configured to perform MAC address filtering on received packets, process MAC headers of received packets by verifying data integrity, remove preambles and padding, and provide packet content for processing by higher layers. MAC circuitry 1016 can be configured to assemble data to be transmitted into packets, that include destination and source addresses along with network control information and error detection hash values.

Processors 1004 can be one or more of: combination of: a processor, core, graphics processing unit (GPU), field programmable gate array (FPGA), application specific integrated circuit (ASIC), or other programmable hardware device that allow programming of network interface 1000. For example, a “smart network interface” or SmartNIC can provide packet processing capabilities in the network interface using processors 1004.

Processors 1004 can include a programmable processing pipeline or offload circuitries that is programmable by P4, Software for Open Networking in the Cloud (SONiC), Broadcom® Network Programming Language (NPL), NVIDIA® CUDA®, NVIDIA® DOCA™, Data Plane Development Kit (DPDK), OpenDataPlane (ODP), Infrastructure Programmer Development Kit (IPDK), eBPF, x86 compatible executable binaries or other executable binaries. A programmable processing pipeline can include one or more match-action units (MAUs) that are configured based on a programmable pipeline language instruction set. Processors, FPGAs, other specialized processors, controllers, devices, and/or circuits can be used utilized for packet processing or packet modification. Ternary content-addressable memory (TCAM) can be used for parallel match-action or look-up operations on packet header content. Processors 904 can be configured to perform an RPC interface, as described herein.

Packet allocator 1024 can provide distribution of received packets for processing by multiple CPUs or cores using receive side scaling (RSS). When packet allocator 1024 uses RSS, packet allocator 1024 can calculate a hash or make another determination based on contents of a received packet to determine which CPU or core is to process a packet.

Interrupt coalesce 1022 can perform interrupt moderation whereby interrupt coalesce 1022 waits for multiple packets to arrive, or for a time-out to expire, before generating an interrupt to host system to process received packet(s). Receive Segment Coalescing (RSC) can be performed by network interface 1000 whereby portions of incoming packets are combined into segments of a packet. Network interface 1000 provides this coalesced packet to an application.

Direct memory access (DMA) engine 1052 can copy a packet header, packet payload, and/or descriptor directly from host memory to the network interface or vice versa, instead of copying the packet to an intermediate buffer at the host and then using another copy operation from the intermediate buffer to the destination buffer.

Memory 1010 can be volatile and/or non-volatile memory device and can store any queue or instructions used to program network interface 1000. Transmit traffic manager can schedule transmission of packets from transmit queue 1006. Transmit queue 1006 can include data or references to data for transmission by network interface. Receive queue 1008 can include data or references to data that was received by network interface from a network. Descriptor queues 1020 can include descriptors that reference data or packets in transmit queue 1006 or receive queue 1008. Bus interface 1012 can provide an interface with host device (not depicted). For example, bus interface 1012 can be compatible with or based at least in part on PCI, PCIe, PCI-x, Serial ATA, and/or USB (although other interconnection standards may be used), or proprietary variations thereof.

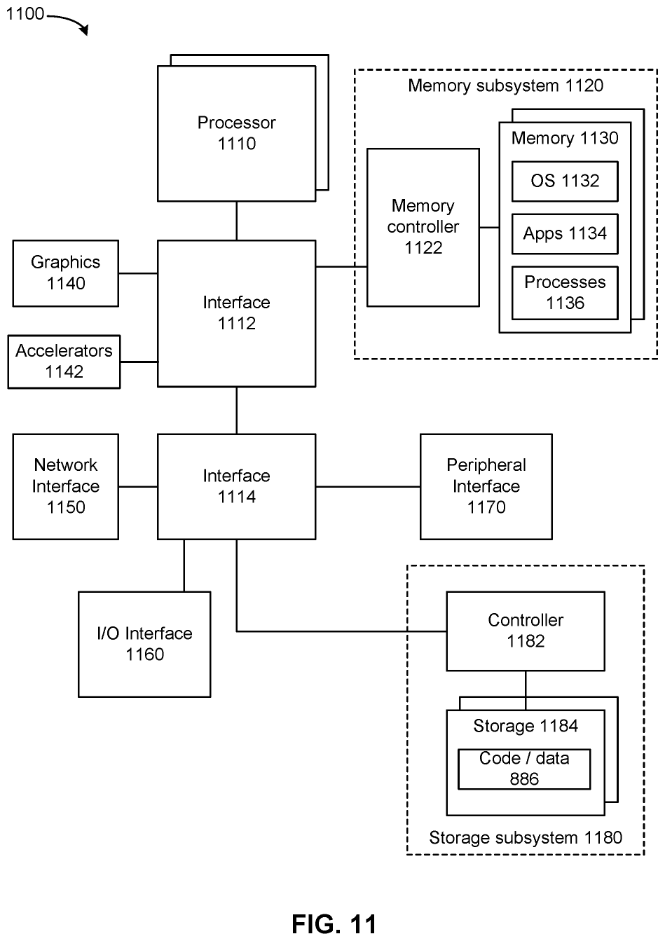

FIG. 11 depicts a system. The system can use embodiments described herein to configure a network interface device to perform linearization and transfer of objects and provide an RPC interface, as described herein. System 1100 includes processors 1110, which provides processing, operation management, and execution of instructions for system 1100. Processors 1110 can include any type of microprocessor, central processing unit (CPU), graphics processing unit (GPU), XPU, processing core, or other processing hardware to provide processing for system 1100, or a combination of processors. An XPU can include one or more of: a CPU, a graphics processing unit (GPU), general purpose GPU (GPGPU), and/or other processing units (e.g., accelerators or programmable or fixed function FPGAs). Processors 1110 controls the overall operation of system 1100, and can be or include, one or more programmable general-purpose or special-purpose microprocessors, digital signal processors (DSPs), programmable controllers, application specific integrated circuits (ASICs), programmable logic devices (PLDs), or the like, or a combination of such devices. Processors 1110 can include one or more processor sockets.

In some examples, interface 1112 and/or interface 1114 can include a switch (e.g., CXL switch) that provides device interfaces between processors 1110 and other devices (e.g., memory subsystem 1120, graphics 1140, accelerators 1142, network interface 1150, and so forth).

In one example, system 1100 includes interface 1112 coupled to processors 1110, which can represent a higher speed interface or a high throughput interface for system components that needs higher bandwidth connections, such as memory subsystem 1120 or graphics interface components 1140, or accelerators 1142. Interface 1112 represents an interface circuit, which can be a standalone component or integrated onto a processor die.

Accelerators 1142 can be a programmable or fixed function offload engine that can be accessed or used by a processors 1110. For example, an accelerator among accelerators 1142 can provide compression (DC) capability, cryptography services such as public key encryption (PKE), cipher, hash/authentication capabilities, decryption, or other capabilities or services. In some cases, accelerators 1142 can be integrated into a CPU socket (e.g., a connector to a motherboard or circuit board that includes a CPU and provides an electrical interface with the CPU). For example, accelerators 1142 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 1142 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 1120 represents the main memory of system 1100 and provides storage for code to be executed by processors 1110, or data values to be used in executing a routine. Memory subsystem 1120 can include one or more memory devices 1130 such as read-only memory (ROM), flash memory, one or more varieties of random access memory (RAM) such as DRAM, or other memory devices, or a combination of such devices. Memory 1130 stores and hosts, among other things, operating system (OS) 1132 to provide a software platform for execution of instructions in system 1100. Additionally, applications 1134 can execute on the software platform of OS 1132 from memory 1130. Applications 1134 represent programs that have their own operational logic to perform execution of one or more functions. Applications 1134 and/or processes 1136 can refer instead or additionally to a virtual machine (VM), container, microservice, processor, or other software. Processes 1136 represent agents or routines that provide auxiliary functions to OS 1132 or one or more applications 1134 or a combination. OS 1132, applications 1134, and processes 1136 provide software logic to provide functions for system 1100. In one example, memory subsystem 1120 includes memory controller 1122, which is a memory controller to generate and issue commands to memory 1130. It will be understood that memory controller 1122 could be a physical part of processors 1110 or a physical part of interface 1112. For example, memory controller 1122 can be an integrated memory controller, integrated onto a circuit with processors 1110.

In some examples, OS 1132 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on one or more processors sold or designed by Intel®, ARM®, AMD®, Qualcomm®, IBM®, Nvidia®, Broadcom®, Texas Instruments®, among others. In some examples, OS 1132 and/or a driver can configure network interface 1150 to perform linearization and transfer of objects and provide an RPC interface, as described herein.

While not specifically illustrated, it will be understood that system 1100 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, Compute Express Link (CXL), a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 1100 includes interface 1114, which can be coupled to interface 1112. In one example, interface 1114 represents an interface circuit, which can include standalone components and integrated circuitry. In one example, multiple user interface components or peripheral components, or both, couple to interface 1114. Network interface 1150 provides system 1100 the ability to communicate with remote devices (e.g., servers or other computing devices) over one or more networks. Network interface 1150 can include an Ethernet adapter, wireless interconnection components, cellular network interconnection components, USB (universal serial bus), or other wired or wireless standards-based or proprietary interfaces. Network interface 1150 can transmit data to a device that is in the same data center or rack or a remote device, which can include sending data stored in memory. Network interface 1150 can receive data from a remote device, which can include storing received data into memory.

In some examples, network interface 1150 can be implemented as a network interface controller, network interface card, a host fabric interface (HFI), or host bus adapter (HBA), and such examples can be interchangeable. Network interface 1150 can be coupled to one or more servers using a bus, PCIe, CXL, or DDR. Network interface 1150 may be embodied as part of a system-on-a-chip (SoC) that includes one or more processors, or included on a multichip package that also contains one or more processors. In some examples, network interface 1150 can perform linearization and transfer of objects and provide an RPC interface, as described herein. Network interface 1150 can also provide a common communication abstraction interface when using shared inter-process memory to hide destination location complexity from a developer. Under a network abstraction, if the destination is local, then optimizations are possible such as replacing the TCP stack by direct memory access, and potentially not requiring inflight data encryption or data transformation.

Some examples of network device 1150 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

In one example, system 1100 includes storage subsystem 1180 to store data in a nonvolatile manner. In one example, in certain system implementations, at least certain components of storage 1180 can overlap with components of memory subsystem 1120. Storage subsystem 1180 includes storage device(s) 1184, which can be or include any conventional medium for storing large amounts of data in a nonvolatile manner, such as one or more magnetic, solid state, or optical based disks, or a combination. Storage 1184 holds code or instructions and data 1186 in a persistent state (e.g., the value is retained despite interruption of power to system 1100). Storage 1184 can be generically considered to be a “memory,” although memory 1130 is typically the executing or operating memory to provide instructions to processors 1110. Whereas storage 1184 is nonvolatile, memory 1130 can include volatile memory (e.g., the value or state of the data is indeterminate if power is interrupted to system 1100). In one example, storage subsystem 1180 includes controller 1182 to interface with storage 1184. In one example controller 1182 is a physical part of interface 1114 or processors 1110 or can include circuits or logic in processors 1110 and interface 1114.

In an example, system 1100 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as Non-volatile Memory Express (NVMe) over Fabrics (NVMe-oF) or NVMe.

Communications between devices can take place using a network, interconnect, or circuitry that provides chip-to-chip communications, die-to-die communications, packet-based communications, communications over a device interface, fabric-based communications, and so forth. A die-to-die communications can be consistent with Embedded Multi-Die Interconnect Bridge (EMIB).

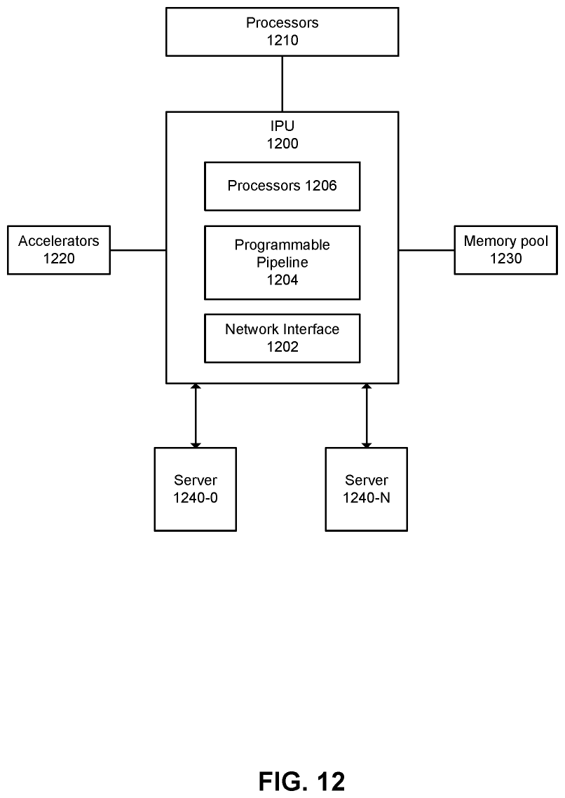

FIG. 12 depicts an example system. Network interface device 1200 manages performance of one or more processes using one or more of processors 1206, processors 1210, accelerators 1220, memory pool 1230, or servers 1240-0 to 1240-N, where N is an integer of 1 or more. In some examples, processors 1206 of network interface device 1200 can execute one or more processes, applications, VMs, containers, microservices, and so forth that request performance of workloads by one or more of: processors 1210, accelerators 1220, memory pool 1230, and/or servers 1240-0 to 1240-N. Network interface device 1200 can utilize network interface 1202 or one or more device interfaces to communicate with processors 1210, accelerators 1220, memory pool 1230, and/or servers 1240-0 to 1240-N. Network interface device 1200 can utilize programmable pipeline 1204 to process packets that are to be transmitted from network interface 1202 or packets received from network interface 1202.

Programmable pipeline 1204 and/or processors 1206 can be configured or programmed using languages based on one or more of: P4, Software for Open Networking in the Cloud (SONiC), C, Python, Broadcom Network Programming Language (NPL), NVIDIA® CUDA®, NVIDIA® DOCA™, Infrastructure Programmer Development Kit (IPDK), eBPF, or x86 compatible executable binaries or other executable binaries. Programmable pipeline 1204 and/or processors 1206 can be configured to separately perform a service and RPC interface as well as to perform linearization and transfer of objects, as described herein.

Embodiments herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. Examples described herein can be implemented as a System-on-Chip (“SoC”). In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, m ay also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”’

Illustrative examples of the devices, systems, and methods disclosed herein are provided below. An embodiment of the devices, systems, and methods may include any one or more, and any combination of, the examples described below.

Flow diagrams as illustrated herein provide examples of sequences of various process actions. The flow diagrams can indicate operations to be executed by a software or firmware routine, as well as physical operations. In some embodiments, a flow diagram can illustrate the state of a finite state machine (FSM), which can be implemented in hardware and/or software. Although shown in a particular sequence or order, unless otherwise specified, the order of the actions can be modified. Thus, the illustrated embodiments should be understood only as an example, and the process can be performed in a different order, and some actions can be performed in parallel. Additionally, one or more actions can be omitted in various embodiments; thus, not all actions are required in every embodiment. Other process flows are possible.

Example 1 includes one or more examples and an apparatus comprising: a network interface device comprising: packet processing circuitry and circuitry to: execute a first process to provide a remote procedure call (RPC) interface for a second process, wherein the second process comprises a business logic, resource and deployment definitions of the first and second processes are based on an Interface Description Language (IDL) and a memory allocation, and the memory allocation among the processes provides share at least one RPC message as at least one formatted object accessible from memory.

Example 2 includes one or more examples, wherein to provide the RPC interface, the first process is to utilize one or more accelerator devices that perform one or more of: data transformation, encryption, reliable transport, load balancing, traffic routing, secure key storage, authentication, and/or observability.

Example 3 includes one or more examples, wherein the memory allocation comprises one or more of: arena based memory allocation, non-arena based memory allocation, memory allocation near processing cores, processing requirements for security, observability and data transformation, and/or request and completion queues.

Example 4 includes one or more examples, wherein a shepherding layer is to provide communication between the partitioned processes to utilize direct memory access (DMA), shared memory, polling threads, and/or timers.

Example 5 includes one or more examples, wherein the first process and the second process are to share a linearized object structure comprising a C++ object with member data references in one or more contiguous memory blocks.

Example 6 includes one or more examples, wherein the first service is to cause a network interface device to linearize at least one object and store the linearized at least one object into memory for access by the second service.

Example 7 includes one or more examples, comprising circuitry is to perform linearization of the at least one object and transmit the linearized at least one object to memory accessible to the first process.

Example 8 includes one or more examples, wherein the network interface device comprises one or more of: a network interface controller (NIC), a remote direct memory access (RDMA)-enabled NIC, SmartNIC, router, switch, forwarding element, infrastructure processing unit (IPU), data processing unit (DPU), accelerator, or network-attached appliance

Example 9 includes one or more examples, and includes a non-transitory computer-readable medium comprising instructions stored thereon, that if executed by one or more processors, cause the one or more processors to: a compiler to generate first and second processes, wherein the first process comprises a business logic, the second process is to provide a remote procedure call (RPC) interface for the first process, and a memory allocation among the first and second processes permits sharing at least one RPC message as at least one formatted object accessible from memory.

Example 10 includes one or more examples, wherein to provide the RPC interface, the second process is to utilize one or more accelerator devices that perform one or more of: data transformation, encryption, reliable transport, load balancing, traffic routing, secure key storage, authentication, and/or observability.

Example 11 includes one or more examples, wherein the memory allocation comprises one or more of: arena based memory allocation, non-arena based memory allocation, memory allocation near processing cores, processing requirements for security, observability and data transformation, and/or request and completion queues.

Example 12 includes one or more examples, wherein the compiler is to generate a shepherding layer to provide communication between the partitioned processes to utilize direct memory access (DMA), shared memory, polling threads, and/or timers.

Example 13 includes one or more examples, wherein the first process and the second process are to share a linearized object structure comprising a C++ object with member data references in one or more contiguous memory blocks.

Example 14 includes one or more examples, wherein the first service is to cause a network interface device to linearize at least one object and store the linearized at least one object into memory for access by the second service.

Example 15 includes one or more examples, wherein circuitry is to perform linearization of the at least one object and transmit the linearized at least one object to memory accessible to the first process.

Example 16 includes one or more examples, wherein the compiler is to generate programming language classes and object access methods for a linearized structure for a software and data structure template for input to the network interface device and circuitry to perform linearization of the at least one object.

Example 17 includes one or more examples, and includes a method comprising: in a data center: a first process, executed by a server, accessing a second process, executed by a network interface device, wherein the second process provides a remote procedure call (RPC) interface for the first process and allocating memory to share at least one RPC message as at least one formatted object among the first and second processes.

Example 18 includes one or more examples, wherein the at least one formatted object comprises a linearized object structure comprising a C++ object with member data references in one or more contiguous memory blocks.

Example 19 includes one or more examples, comprising: storing the linearized object structure as a C++ object with member data references in one or more contiguous memory blocks.

Example 20 includes one or more examples, wherein the second process provides a RPC interface for the first process comprises utilizing one or more accelerator devices that perform one or more of: data transformation, encryption, reliable transport, load balancing, traffic routing, secure key storage, authentication, and/or observability.

What is claimed is:

1. An apparatus comprising:
a network interface device comprising:
packet processing circuitry and
circuitry to:
execute a first process to provide a remote procedure call (RPC) interface for a second process, wherein
the second process comprises a business logic,
resource and deployment definitions of the first and second processes are based on an Interface Description Language (IDL) and a memory allocation, and
the memory allocation among the processes provides share at least one RPC message as at least one formatted object accessible from memory.

2. The apparatus of claim 1, wherein to provide the RPC interface, the first process is to utilize one or more accelerator devices that perform one or more of: data transformation, encryption, reliable transport, load balancing, traffic routing, secure key storage, authentication, and/or observability.

3. The apparatus of claim 1, wherein the memory allocation comprises one or more of: arena based memory allocation, non-arena based memory allocation, memory allocation near processing cores, processing requirements for security, observability and data transformation, and/or request and completion queues.

4. The apparatus of claim 1, wherein a shepherding layer is to provide communication between the partitioned processes to utilize direct memory access (DMA), shared memory, polling threads, and/or timers.

5. The apparatus of claim 1, wherein the first process and the second process are to share a linearized object structure comprising a C++ object with member data references in one or more contiguous memory blocks.

6. The apparatus of claim 5, wherein the first service is to cause a network interface device to linearize at least one object and store the linearized at least one object into memory for access by the second service.

7. The apparatus of claim 5, comprising circuitry is to perform linearization of the at least one object and transmit the linearized at least one object to memory accessible to the first process.

8. The apparatus of claim 1, wherein the network interface device comprises one or more of: a network interface controller (NIC), a remote direct memory access (RDMA)-enabled NIC, SmartNIC, router, switch, forwarding element, infrastructure processing unit (IPU), data processing unit (DPU), accelerator, or network-attached appliance.

9. A non-transitory computer-readable medium comprising instructions stored thereon, that if executed by one or more processors, cause the one or more processors to:
a compiler to generate first and second processes, wherein
the first process comprises a business logic,
the second process is to provide a remote procedure call (RPC) interface for the first process, and
a memory allocation among the first and second processes permits sharing at least one RPC message as at least one formatted object accessible from memory.

10. The computer-readable medium of claim 9, wherein to provide the RPC interface, the second process is to utilize one or more accelerator devices that perform one or more of: data transformation, encryption, reliable transport, load balancing, traffic routing, secure key storage, authentication, and/or observability.

11. The computer-readable medium of claim 9, wherein the memory allocation comprises one or more of: arena based memory allocation, non-arena based memory allocation, memory allocation near processing cores, processing requirements for security, observability and data transformation, and/or request and completion queues.

12. The computer-readable medium of claim 9, wherein the compiler is to generate a shepherding layer to provide communication between the partitioned processes to utilize direct memory access (DMA), shared memory, polling threads, and/or timers.

13. The computer-readable medium of claim 9, wherein the first process and the second process are to share a linearized object structure comprising a C++ object with member data references in one or more contiguous memory blocks.

14. The computer-readable medium of claim 13, wherein the first service is to cause a network interface device to linearize at least one object and store the linearized at least one object into memory for access by the second service.

15. The computer-readable medium of claim 13, wherein circuitry is to perform linearization of the at least one object and transmit the linearized at least one object to memory accessible to the first process.

16. The computer-readable medium of claim 13, wherein the compiler is to generate programming language classes and object access methods for a linearized structure for a software and data structure template for input to the network interface device and circuitry to perform linearization of the at least one object.

17. A method comprising:
in a data center:
a first process, executed by a server, accessing a second process, executed by a network interface device, wherein the second process provides a remote procedure call (RPC) interface for the first process and
allocating memory to share at least one RPC message as at least one formatted object among the first and second processes.

18. The method of claim 17, wherein the at least one formatted object comprises a linearized object structure comprising a C++ object with member data references in one or more contiguous memory blocks.

19. The method of claim 17, comprising:
storing the linearized object structure as a C++ object with member data references in one or more contiguous memory blocks.

20. The method of claim 18, wherein the second process provides a RPC interface for the first process comprises utilizing one or more accelerator devices that perform one or more of: data transformation, encryption, reliable transport, load balancing, traffic routing, secure key storage, authentication, and/or observability.
